(19) United States
(12) Patent Application Publication
(10) Pub. No.: US 2022/0095099 A1
(43) Pub. Date: Mar. 24, 2022

(54) BASE STATION APPARATUS, MOBILE STATION APPARATUS, AND COMMUNICATION METHOD

(71) Applicants: SHARP KABUSHIKI KAISHA, Sakai City, Osaka (JP); FG Innovation Company Limited, Tuen Mun (HK)

(72) Inventors: SEIJI SATO, Sakai City, Osaka (JP); HIDEO NAMBA, Sakai City, Osaka (JP); YASUHIRO HAMAGUCHI, Sakai City, Osaka (JP)

(21) Appl. No.: 17/429,138

(22) PCT Filed: Jan. 31, 2020
(86) PCT No.: PCT/JP2020/003798

§ 371 Date: Aug. 6, 2021

(30) Foreign Application Priority Data
Feb. 14, 2019 (JP) 2019-024514

(51) Int. Cl. H04W 8/26; H04W 36/00

(52) U.S. Cl. CPC H04W 8/26; H04W 36/0055

(57) ABSTRACT

In a case in which a plurality of mobile station apparatuses to which a plurality of sub-devices are connected through Ethernet (registered trade name) are connected to a base station apparatus, efficient communication needs to be performed through an appropriate routing process. A base station apparatus of a communication system including at least the base station apparatus and a mobile station apparatus, the base station apparatus including a controller configured to control a core net interface unit, a PDCP layer configured to handle a PDCP-PDU, and an RRC layer configured to perform radio resource control, in which the PDCP-PDU is able to use at least an IP packet or an Ethernet (registered trade name) frame, and in a case that the controller is configured such that the PDCP-PDU uses the Ethernet (registered trade name) frame, the base station apparatus receives, from the mobile station apparatus, an RRC message including a MAC address list of Ethernet (registered trade name).

### TECHNICAL FIELD

The present invention relates to a base station apparatus, a mobile station apparatus, and a communication method for these apparatuses. This application claims priority based on JP 2019-024514 filed on Feb. 14, 2019, the contents of which are incorporated herein by reference.

### BACKGROUND ART

The 3rd Generation Partnership Project (3GPP), which is a standardization organization, has standardized the specifications of Evolved Universal Terrestrial Radio Access (hereinafter referred to as “EUTRA” or “LTE”) into which the third-generation mobile communication method has evolved and the fourth-generation mobile communication method “Advanced EUTRA” (also referred to as “LTE-Advanced” or “LTE-A”) into which EUTRA has further evolved, and mobile communications using the specifications have been commercialized in many countries (NPL 1). Furthermore, in recent years, in the 3GPP, technical study and standardization of New Radio (NR), which is the fifth-generation mobile communication method (NPL 2), has progressed. The fifth-generation mobile communication method employs techniques such as enhanced Mobile BroadBand (eMBB), Ultra-Reliable and Low Latency Communication (URLLC), and massive Machine Type Communication (mMTC) to implement Internet of Things (IoT). In addition, application of a wireless network of a fifth-generation mobile communication method to Industory IoT (IIoT) has also been discussed, and transmission and/or reception of Internet Protocol (IP)-based data as well as data on a non-IP-based protocol such as Ethernet (registered trade name) directly on a wireless network have been discussed (NPL 3).

### CITATION LIST

### Non Patent Literature

NPL 1: “3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 15),” 3GPP TS 36.300 V15.3.0 (2018-09)
NPL 2: “3rd Generation Partnership Project; Technical Specification Group Radio Access Network; NR; NR and NG-RAN Overall Description; Stage 2 (Release 15),” 3GPP TS 38.300 V15.3.0 (2018-09)
NPL 3: “3GPP TSG-RAN meeting #81; RP-182090; Title: Study on NR Industrial Internet of Things (IoT)”

### SUMMARY OF INVENTION

### Technical Problem

In a case that a plurality of mobile station apparatuses each connecting a plurality of sub-devices with Ethernet (registered trade name) are connected to a base station apparatus, efficient communication needs to be performed through an appropriate routing process.

### Solution to Problem

(1) The present invention has been conceived to solve the above-described problem, and a base station apparatus according to an aspect of the present invention is a base station apparatus of a communication system including at least the base station apparatus and a mobile station apparatus, the base station apparatus including a controller configured to control a core network interface unit,

a PDCP layer configured to handle a PDCP-PDU, and
an RRC layer configured to perform radio resource control, in which at least an IP packet or an Ethernet (registered trade name) datagram is usable for the PDCP-PDU, and in a case that the controller is configured such that the Ethernet (registered trade name) datagram is used for the PDCP-PDU, the base station apparatus receives, from the mobile station apparatus, an RRC message including a MAC address list used in the Ethernet (registered trade name) datagram.

(2) In addition, a base station apparatus according to an aspect of the present invention is the above-described base station apparatus in which the MAC address list includes a MAC address used in an Ethernet (registered trade name) datagram used by a plurality of terminal apparatuses connected to the mobile station apparatus and an index for the MAC address used in the Ethernet (registered trade name) datagram, in which in a case that the PDCP-PDU included in a signal that the base station apparatus receives from the core network interface unit or any of the plurality of terminal apparatuses connected to the mobile station apparatus is an Ethernet (registered trade name) datagram, the controller checks whether the MAC address of a transmission destination of the received Ethernet (registered trade name) datagram is included in the MAC address list, and in a case that the MAC address of the transmission destination is included in the MAC address list, the controller transmits the PDCP-PDU including the Ethernet (registered trade name) datagram to the mobile station apparatus.

(3) In addition, a base station apparatus according to an aspect of the present invention is the above-described base station apparatus in which the controller manages a MAC address blacklist, the MAC address blacklist includes one or a plurality of the MAC addresses used in the Ethernet (registered trade name) datagram as an element, and in a case that the PDCP-PDU included in a signal that the base station apparatus receives from the core network interface unit or any of the plurality of terminal apparatuses connected to the mobile station apparatus is an Ethernet (registered trade name) datagram and a MAC address included in the Ethernet (registered trade name) datagram is included in the MAC address blacklist, the Ethernet (registered trade name) datagram is not transmitted.

(4) In addition, a mobile station apparatus according to an aspect of the present invention is a mobile station apparatus of a communication system including at least a base station apparatus and the mobile station apparatus, the mobile station apparatus including a controller configured to control a PDCP layer configured to handle a PDCP-PDU and an RRC layer configured to perform radio resource control, in which at least an IP packet or an Ethernet (registered trade name) datagram is usable for the PDCP-PDU, and in a case that the controller is configured such that the Ethernet (registered trade name) datagram is used for the PDCP-PDU, an RRC message including a MAC address list including a MAC address used as a transmission destination address used in the Ethernet (registered trade name) datagram is transmitted to the base station apparatus.

(5) In addition, a mobile station apparatus according to an aspect of the present invention is the mobile station apparatus, in which one or more sub-devices are connected to the mobile apparatus, and a MAC address included in the MAC address list is allocated to each of the one or more sub-devices.

(6) In addition, a mobile station apparatus according to an aspect of the present invention is the mobile station apparatus, in which, in a case that MAC address(es) used by the one or more connected sub-devices or the number of the MAC addresses is changed, the RRC message including the MAC address list is transmitted to the base station apparatus.

(7) In addition, a mobile station apparatus according to an aspect of the present invention is the mobile station apparatus, in which information for indicating whether to perform a function of exchanging MAC address information for handover is received from the base station apparatus, and the RRC message including the MAC address list is transmitted to the base station apparatus after the handover process, based on the information for indicating whether to perform the function of exchanging the MAC address information for handover.

(8) In addition, a communication method according to an aspect of the present invention is a communication method performed by a mobile station apparatus of a communication system including at least a base station apparatus and the mobile station apparatus, the communication method including receiving a PDCP-PDU, in a case that the PDCP-PDU is at least an IP packet or an Ethernet (registered trade name) datagram, and the mobile station apparatus is configured such that the Ethernet (registered trade name) datagram is used for the PDCP-PDU, transmitting, to the base station apparatus, an RRC message including a MAC address list including a MAC address used as a transmission destination address used in the Ethernet (registered trade name) datagram.

### Advantageous Effects of Invention

According to an aspect of the present invention, in a case that a plurality of mobile station apparatuses each connecting a plurality of sub-devices with Ethernet (registered trade name) are connected to a base station apparatus, efficient communication can be performed through an appropriate routing process.

### BRIEF DESCRIPTION OF DRAWINGS

FIG. 1 is a diagram illustrating an example of an overview of a communication system according to an aspect of the present invention.

FIG. 2 is a diagram illustrating an example of a configuration of a base station apparatus according to an aspect of the present invention.

FIG. 3 is a diagram illustrating an example of a configuration of a mobile station apparatus according to an aspect of the present invention.

FIG. 4 is a diagram illustrating an example of a configuration of a MAC address list of a base station apparatus according to an aspect of the present invention.

FIG. 5 is a diagram illustrating an example of a position of a flow of an update procedure for a MAC address list of a base station apparatus according to an aspect of the present invention.

FIG. 6 is a diagram illustrating an example of a flow of data transmission and/or reception between a base station apparatus and a mobile station apparatus according to an aspect of the present invention.

### DESCRIPTION OF EMBODIMENTS

### First Embodiment

Hereinafter, a first embodiment of the present invention will be described with reference to the drawings.

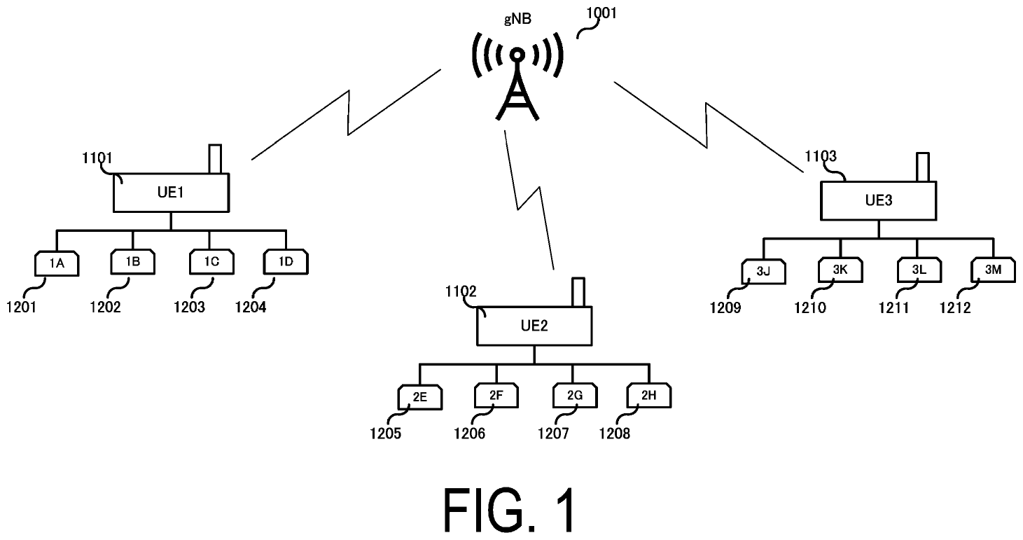

FIG. 1 illustrates an example of an overview of a communication system according to the present embodiment. Reference numeral 1001 represents a base station apparatus (gNB), reference numerals 1101 to 1103 represent mobile station apparatuses (UE), and reference numerals 1201 to 1212 represent sub-devices. The base station apparatus and the mobile station apparatuses are connected to each other in radio links. In addition, each of the mobile station apparatuses is connected to one or a plurality of sub-devices with Ethernet (registered trade name) or the like. A unique Media Access Control (MAC) address is allocated to each of the sub-devices to enable the sub-devices to communicate with other sub-devices by specifying the MAC address of the communication destination. A communication data unit that uses a MAC address allocated to a sub-device is called an Ethernet (registered trade name) datagram. Such an Ethernet (registered trade name) datagram does not need to include all types of information such as a preamble, frame start information, and frame check information constituting a frame defined by the IEEE 802.3, but is only required to include at least information indicating the MAC address of a transmission destination and the data body. However, in a case that communication with a sub-device connected to another mobile station apparatus is performed, the communication is performed via the base station apparatus; however, the base station apparatus does not know the mobile station apparatus to which the sub-device with the corresponding MAC address is connected and thus the base station apparatus needs to communicate with all of the mobile station apparatuses connected to the base station apparatus, which causes the problem of inefficiency. Thus, an aspect for solving this problem with the present invention will be described.

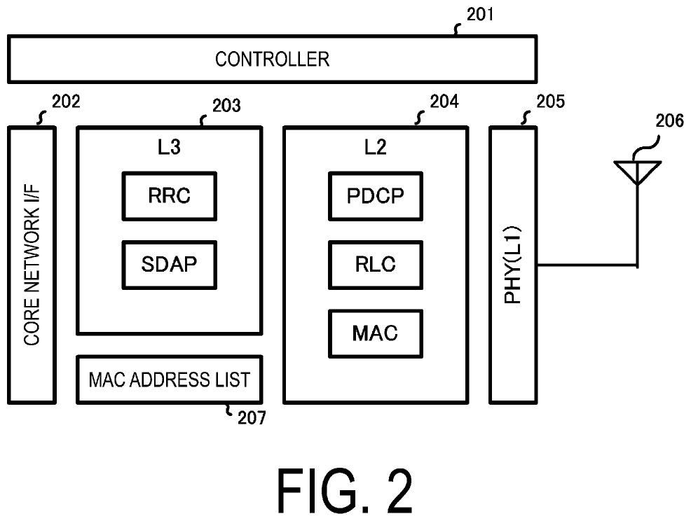

FIG. 2 illustrates an example of a configuration of the base station apparatus according to an aspect of the present invention. In FIG. 2, reference numeral 201 represents a controller that controls the entire base station apparatus. Reference numeral 202 represents a core network I/F, which enables the base station apparatus to transmit and/or receive control information and user data to and/or from a core network to which the base station apparatus is connected. Reference numeral 203 represents a layer 3 which includes the Radio Resource Control (RRC) for managing the control plane and the Service Data Adaptation Protocol (SDAP) for managing the user plane. Reference numeral 204 represents a layer 2 which includes the Packet Data Convergence Protocol (PDCP) for performing data header compression, encryption, and the like, the Radio Link Control (RLC) for performing ARQ retransmission control, sequence alignment, and the like, and the MAC for controlling radio resource allocation, data mapping, hybrid ARQ, and the like. Further, it should be noted that the MAC of the layer 2 204 has nothing to do with the MAC addresses allocated to the aforementioned sub-devices. Reference numeral 205 represents a PHY (layer 1) section for performing error correction coding, modulation/demodulation, and transmission and/or reception processes using physical resources such as antenna multiplexing. Reference numeral 206 represents an antenna unit for performing transmission and/or reception of radio signals to and/or from the mobile station apparatuses. Reference numeral 207 represents a MAC address list for managing the MAC addresses of the sub-devices connected to each of the mobile station apparatuses connected to the base station apparatus.

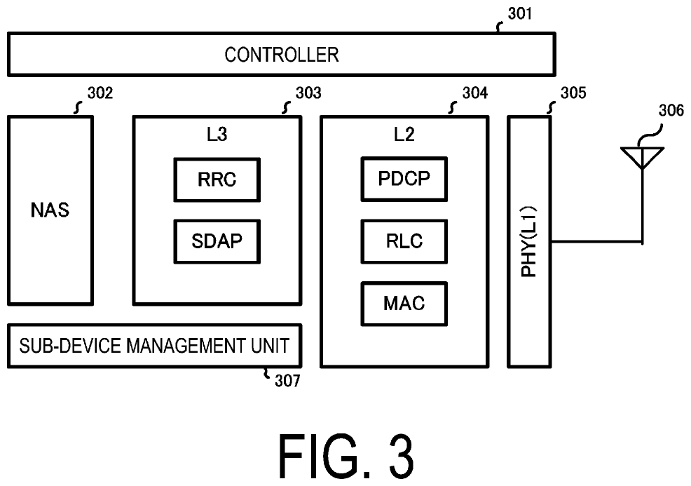

FIG. 3 illustrates an example of a configuration of a mobile station apparatus according to an aspect of the present invention. In FIG. 3, reference numeral 301 represents a controller that controls the entire mobile station apparatus. Reference numeral 302 represents the Non Access Stratum (NAS), which communicates with the NAS on the core network side using the Access Stratum (AS) of the mobile station apparatus and the base station apparatus. Reference numeral 303 represents a layer 3 which includes the Radio Resource Control (RRC) for managing the control plane and the Service Data Adaptation Protocol (SDAP) for managing the user plane. Reference numeral 304 represents a layer 2 which includes the Packet Data Convergence Protocol (PDCP) for performing data header compression, encryption, and the like, the Radio Link Control (RLC) for performing ARQ retransmission control, sequence alignment, and the like, and the MAC for controlling radio resource allocation, data mapping, hybrid ARQ, and the like. Further, it should be noted that the MAC of the layer 2 304 has nothing to do with the MAC addresses allocated to the aforementioned sub-devices. Reference numeral 305 represents a PHY (layer 1) section for performing error correction coding, modulation/demodulation, and transmission and/or reception processes using physical resources such as antenna multiplexing. Reference numeral 306 represents an antenna unit for performing transmission and/or reception of radio signals to and/or from the mobile station apparatuses. Reference numeral 307 represents a sub-device management section, which performs connection and disconnection, routing, and management of the MAC address of a sub-device connected to the mobile station apparatus on Ethernet (registered trade name) or the like.

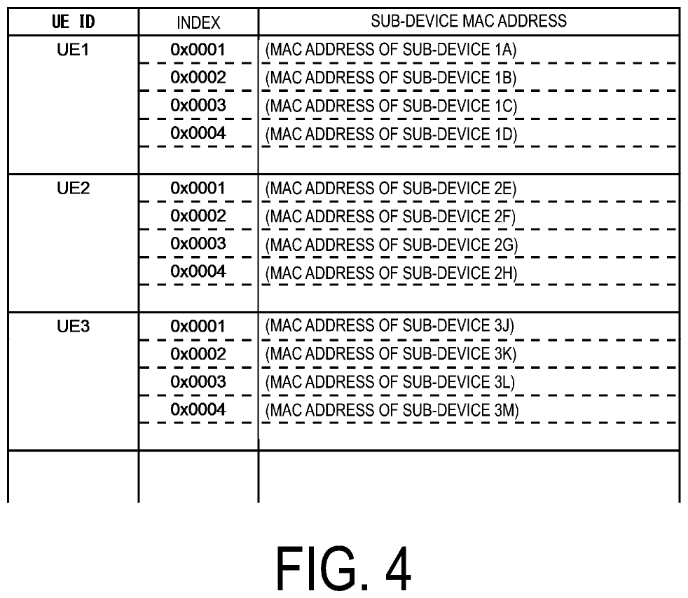

FIG. 4 illustrates a configuration of a MAC address list 207 of the base station apparatus according to the present embodiment. As illustrated in FIG. 4, the MAC addresses of the sub-devices are collectively managed for each UE. Here, a UE ID is used to identify UE connected to the base station apparatus, and a Cell-Radio Network Temporary Identity (C-RNTI), an International Mobile Equipment Identity (IMEI), or the like may be used. In addition, although an index is allocated to the registered MAC address of each sub-device, the index is not explicitly given and the order of registration, for example, may be implicitly used as an index.

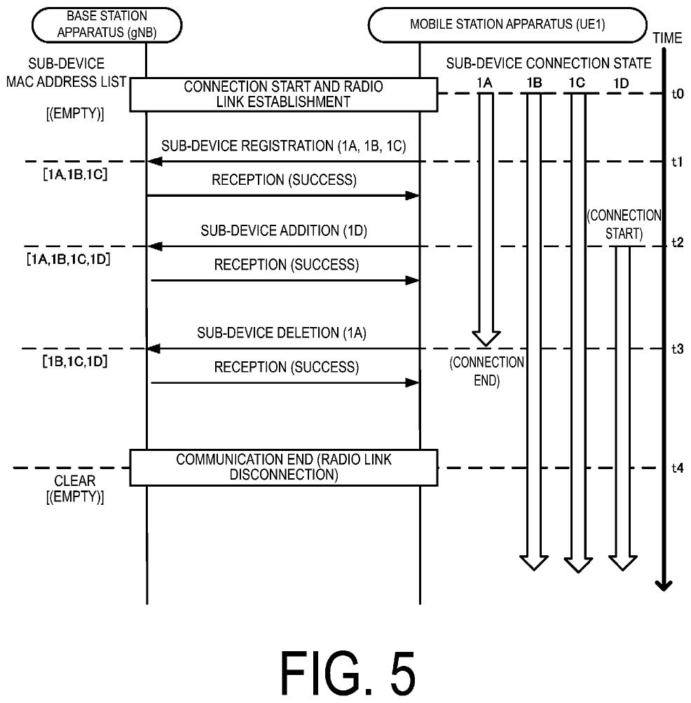

FIG. 5 illustrates a flow of an update procedure for the MAC address list 207 according to the present embodiment. First, it is assumed that, although the base station apparatus (gNB) and a mobile station apparatus 1 (UE1) have not yet established a radio link, sub-devices 1A, 1B, and 1C are connected to the mobile station apparatus. Next, at a time t0, the base station apparatus and the mobile station apparatus start connection to establish a radio link. Next, the mobile station apparatus transmits a sub-device registration message with respect to the connected sub-devices 1A, 1B, and 1C to the base station apparatus along with the MAC addresses of the sub-devices (time t1). In a case of receiving the sub-device registration message from the mobile station apparatus 1, the base station apparatus stores the MAC addresses of the sub-devices 1A, 1B, and 1C included in the message in the MAC address list 207 and transmits a reception (success) message to the mobile station apparatus 1. Further, the reception message may include the content of the sub-device MAC address list record of the mobile station apparatus 1 currently retained by the base station apparatus. Next, at a time t2, in a case that a sub-device 1D starts connection to the mobile station apparatus 1, the mobile station apparatus 1 transmits a sub-device addition message to the base station apparatus along with the MAC address of the sub-device 1D. In a case of receiving the sub-device registration message from the mobile station apparatus 1, the base station apparatus stores the MAC addresses of the sub-device 1D included in the message in the MAC address list 207 and transmits a reception (success) message to the mobile station apparatus 1. Further, the reception message may include the content of the sub-device MAC address list of the mobile station apparatus 1 currently retained by the base station apparatus or may include only the index of the sub-device 1D or the index and the MAC address of the sub-device. Next, in a case that the connection of the sub-device 1A to the mobile station apparatus 1 ends at a time t3, the mobile station apparatus 1 transmits a sub-device deletion message with respect to the sub-device 1A to the base station apparatus. At this time, the mobile station apparatus 1 may include the MAC address of the sub-device 1A to be deleted or may include the index of the sub-device 1A on the MAC address list 207 in the sub-device deletion message. In a case of receiving the sub-device deletion message from the mobile station apparatus 1, the base station apparatus deletes the registration record on the MAC address list 207 specified by the MAC address or the index of the sub-device 1A included in the message and transmits a reception (success) message to the mobile station apparatus 1. Further, the reception message may include the content of the sub-device MAC address list record of the mobile station apparatus 1 currently retained by the base station apparatus or may include the deleted MAC address of the sub-device 1A and/or the index allocated to the sub-device 1A before the deletion. Thereafter, in a case that the communication between the base station apparatus and the mobile station apparatus 1 ends at time t4 and the radio link is disconnected, the base station apparatus deletes the MAC address list record of the mobile station apparatus 1 from the MAC address list 207. Further, the base station apparatus may not transmit the reception messages with respect to each of the messages for registration, addition, and deletion of the sub-devices sent from the mobile station apparatus 1 to the mobile station apparatus 1. Furthermore, each of the messages for registration, addition, and deletion of the sub-devices and the reception messages with respect to the messages may be sent in a message of the RRC or the like, or may be sent in a higher-order message such as the Non Access Stratum (NAS).

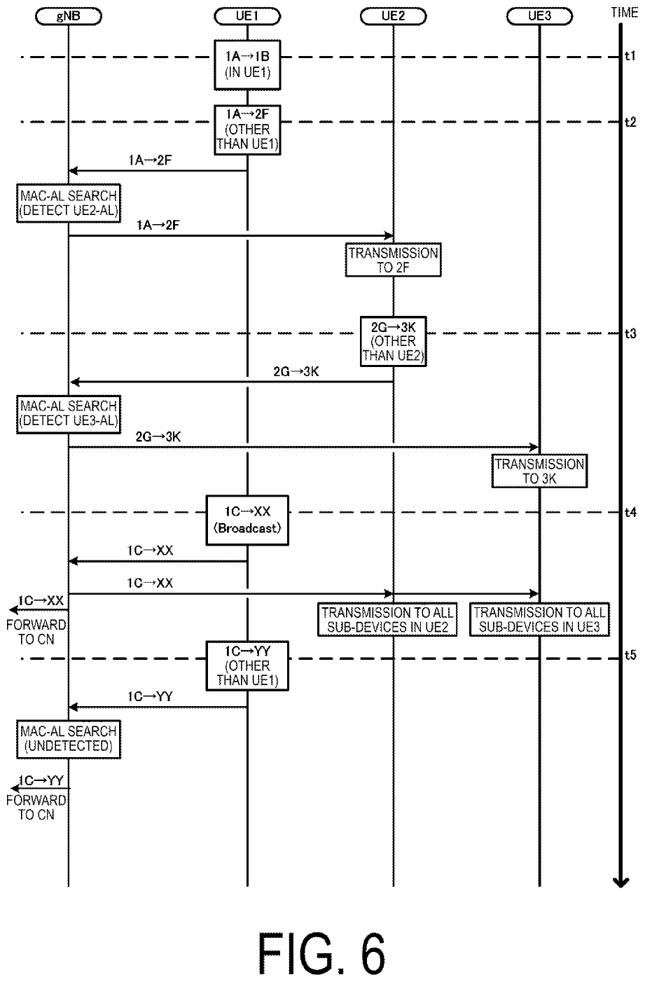

Next, a flow of data transmission and/or reception between the base station apparatus (gNB) and mobile station apparatuses (UE1, UE2, UE3) according to an aspect of the present invention will be described with reference to FIG. 6. First, it is assumed that the gNB, each UE, each of the sub-devices are connected as in FIG. 1 and MAC addresses of the sub-devices of each UE are registered on the MAC address list (MAC-AL) 207 of the gNB as in FIG. 4 according to the procedure illustrated in FIG. 5. At a time t1, the sub-device 1A transmits data to the MAC address of the sub-device 1B as a destination. The UE1 detects that the MAC address that is the destination of the data is that of the sub-device 1B connected to the UE1 and sends the data to the sub-device 1B. Because data transmission and/or reception is completed within the UE1, no data is transmitted to the gNB. Next, at a time t2, the sub-device 1A transmits data (an Ethernet (registered trade name) datagram) to the MAC address of a sub-device 2F as a destination. At this time, the Ethernet (registered trade name) datagram may be used as a PDCP-PDU. The UE1 is unable to detect that the MAC address that is the destination is that of a sub-device connected to the UE1 and forwards the data to the gNB. The gNB searches the MAC address list 207 and detects that the MAC address that is the destination of the data is included in the MAC address record of the UE2 and forwards the data to the UE2. The UE2 detects that the MAC address that is the destination of the data is that of the sub-device 2F connected to the UE2 and forwards the data to the sub-device 2F. Next, at a time t3, a sub-device 2G transmits data to the MAC address of a sub-device 3K as a destination. The UE2 is unable to detect that the MAC address that is the destination of the data is that of a sub-device connected to the UE2 and forwards the data to the gNB. The gNB searches the MAC address list 207 and detects that the MAC address that is the destination of the data is included in the MAC address record of the UE3 and forwards the data to the UE3. The UE3 detects that the MAC address that is the destination of the data is that of the sub-device 3K connected to the UE3 and forwards the data to the sub-device 3K. Next, at a time t4, the sub-device 1C transmits data to a broadcast address that is a destination. The UE1 detects that the MAC address that is the destination of the data is a broadcast address, forwards the data to all of the sub-devices except the sub-device 1C connected to the UE1, and further forwards the data to the gNB. The gNB detects that the MAC address that is the destination of the data is a broadcast address and forwards the data to the UE2 and the UE3 other than the UE1. Furthermore, the data may be forwarded to the core network (CN) and transmitted to UE and a sub-device connected to another gNB. The UE2 and the UE3 detect that the MAC address that is the destination of the data is a broadcast address and forward the data to all sub-devices connected to each. Next, at a time t5, the sub-device 1C transmits data to a MAC address YY that is a destination but is not registered in the MAC address list of the gNB. The UE1 is unable to detect that the MAC address that is the destination is that of a sub-device connected to the UE1 and forward the data to the gNB. Although the gNB searches the MAC address list 207, the gNB is unable to detect the UE with the MAC address record from which the MAC address that is the destination of the data came and forwards the data to the core network. Further, the data may be discarded without being forwarded to the core network.

The base station apparatus may manage data (an Ethernet (registered trade name) datagram) to be discarded on a blacklist without forwarding the data to UE or the core network. As an example, one or more MAC addresses of a device on paths constituting a loop on a network may be registered in the blacklist (a MAC address blacklist) and the base station may refer to the blacklist to be able to discard corresponding data to prevent the data from looping in the loop on the network. The blacklist may be managed by a device on the core network side, and in this case, the base station apparatus may update the blacklist using an NAS message. In addition, the base station apparatus may use a technique such as the spanning tree protocol to detect the MAC address of a device that may interfere with the base station apparatus and update the blacklist.

Further, in a case that a mobile station apparatus performs handover to another base station apparatus, the base station apparatus serving as the handover source transmits a record of the sub-device MAC address list of the mobile station apparatus to the base station apparatus serving as the handover destination and deletes the record of the sub-device MAC address list of the mobile station apparatus from its own MAC address list. The base station apparatus serving as the handover destination registers the record of the MAC address list of the mobile station apparatus received from the base station apparatus serving as the handover source in its own MAC address list. Thus, even after the handover, the sub-devices connected to the mobile station apparatus can continue to communicate without registering their MAC addresses again in the base station apparatus.

The base station apparatus may exchange sub-device MAC address information of the mobile station apparatus with other base station apparatuses at the time of handover, or may not have the function of exchanging sub-device MAC address information for handover. The base station apparatus may notify a terminal apparatus of information indicating whether to perform the function of exchanging the MAC address information for handover with respect to the terminal apparatus. The notification may be included in system information broadcast from the base station apparatus, may be included in control information that each terminal is notified of, or may be included in control information for handover. The terminal apparatus may transmit information for registering the MAC addresses of the sub-devices to the base station apparatus serving as the handover destination after the handover process ends, based on the information indicating whether the base station apparatus performs the function of exchanging the MAC address information for handover. In a case in which the handover process is successful regardless of whether or not the base station apparatus serving as the handover destination performs the function of exchanging the MAC address information for handover, the base station apparatus serving as the handover source may delete the MAC address of a sub-device associated with a corresponding terminal apparatus from the MAC address list.

As described above, according to the base station apparatus and the mobile station apparatus according to an aspect of the present invention, in a case that a plurality of mobile station apparatuses, each connected to a plurality of sub-devices with Ethernet (registered trade name), are connected to the base station apparatus, communication can be performed among sub-devices or via a sub-device and the core network even in a case that data communication using the MAC addresses allocated to the sub-devices (data communication using an Ethernet (registered trade name) datagram) is performed.

Further, a program used for implementing all or some of the functions of the base station apparatus and the mobile station apparatuses described above may be recorded on a computer-readable recording medium, and the program recorded on the recording medium may be read and performed by a computer system to perform processing of each unit. Further, the “computer system” mentioned here is assumed to include an OS and hardware such as a peripheral device.

In addition, the “computer system” is assumed to also include an environment in which a home page is provided (or a display environment) as long as a WWW system is utilized.

In addition, the “computer-readable recording medium” refers to a portable medium such as a flexible disk, a magneto-optical disc, a ROM, or a CD-ROM, and a storage device such as a hard disk built into the computer system. Moreover, the “computer-readable recording medium” is assumed to include a medium that dynamically retains a program for a short period of time, such as a communication line that is used to transmit the program via a network such as the Internet or via a communication line such as a telephone line, and a medium that retains the program for a fixed period of time, such as a volatile memory in the computer system which functions as a server or a client in that case. Furthermore, the above-described program may be one for implementing some of the above-described functions, and also may be one capable of realizing the above-described functions in combination with the program already recorded in the computer system.

In addition, all or some of the functions of the base station apparatus and the mobile station apparatuses may be implemented by aggregating the functions into an integrated circuit. Each functional block may be individually realized as chips, or may be partially or completely integrated into a chip. In addition, a circuit integration technique is not limited to LSI, and may be implemented with a dedicated circuit or a general-purpose processor. Moreover, in a case in which a circuit integration technology with which LSI is replaced appears as the semiconductor technology advances, an integrated circuit based on the technology can also be used.

Although the embodiments of the present invention have been described in detail above referring to the drawings, the specific configuration is not limited to the embodiments, and for example, an amendment to a design that falls within the scope that does not depart from the gist of the present invention is also included.

### INDUSTRIAL APPLICABILITY

The present invention is suitable for being used in wired and wireless communication systems and communication apparatuses.

1. A base station apparatus of a communication system including at least the base station apparatus and a mobile station apparatus, the base station apparatus comprising:
a controller configured to control
a core network interface unit,
a PDCP layer configured to handle a PDCP-PDU, and
an RRC layer configured to perform radio resource control, wherein
at least an IP packet or an Ethernet (registered trade name) datagram is usable for the PDCP-PDU, and
in a case that the controller is configured such that the Ethernet (registered trade name) datagram is used for the PDCP-PDU, the base station apparatus receives, from the mobile station apparatus, an RRC message including a MAC address list used in the Ethernet (registered trade name) datagram.

2. The base station apparatus according to claim 1, wherein
the MAC address list includes a MAC address used in an Ethernet (registered trade name) datagram used by a plurality of terminal apparatuses connected to the mobile station apparatus and an index for the MAC address used in the Ethernet (registered trade name) datagram,
in a case that the PDCP-PDU included in a signal that the base station apparatus receives from the core network interface unit or any of the plurality of terminal apparatuses connected to the mobile station apparatus is an Ethernet (registered trade name) datagram,
the controller checks whether the MAC address of a transmission destination of the received Ethernet (registered trade name) datagram is included in the MAC address list, and
in a case that the MAC address of the transmission destination is included in the MAC address list, the controller transmits the PDCP-PDU including the Ethernet (registered trade name) datagram to the mobile station apparatus.

3. The base station apparatus according to claim 2, wherein
the controller manages a MAC address blacklist,
the MAC address blacklist includes one or a plurality of the MAC addresses used in the Ethernet (registered trade name) datagram as an element, and
in a case that the PDCP-PDU included in a signal that the base station apparatus receives from the core network interface unit or any of the plurality of terminal apparatuses connected to the mobile station apparatus is an Ethernet (registered trade name) datagram and a MAC address included in the Ethernet (registered trade name) datagram is included in the MAC address blacklist, the Ethernet (registered trade name) datagram is not transmitted.

4. A mobile station apparatus of a communication system including at least a base station apparatus and the mobile station apparatus, the mobile station apparatus comprising:
a controller configured to control
a PDCP layer configured to handle a PDCP-PDU, and
an RRC layer configured to perform radio resource control, wherein
at least an IP packet or an Ethernet (registered trade name) datagram is usable for the PDCP-PDU, and
in a case that the controller is configured such that the Ethernet (registered trade name) datagram is used for the PDCP-PDU, an RRC message including a MAC address list including a MAC address used as a transmission destination address used in the Ethernet (registered trade name) datagram is transmitted to the base station apparatus.

5. The mobile station apparatus according to claim 4, wherein
one or more sub-devices are connected to the mobile station apparatus, and
a MAC address included in the MAC address list is allocated to each of the one or more sub-devices.

6. The mobile station apparatus according to claim 5, wherein
in a case that MAC address(es) used by the one or more connected sub-devices or the number of the MAC addresses is changed, the RRC message including the MAC address list is transmitted to the base station apparatus.

7. The mobile station apparatus according to claim 4, wherein
information for indicating whether to perform a function of exchanging MAC address information for handover is received from the base station apparatus, and
the RRC message including the MAC address list is transmitted to the base station apparatus after the handover process, based on the information for indicating whether to perform the function of exchanging the MAC address information for handover.

8. A communication method performed by a mobile station apparatus of a communication system including at least a base station apparatus and the mobile station apparatus, the communication method comprising:
receiving a PDCP-PDU,
in a case that
the PDCP-PDU is at least an IP packet or an Ethernet (registered trade name) datagram, and
the mobile station apparatus is configured such that the Ethernet (registered trade name) datagram is used for the PDCP-PDU,
transmitting, to the base station apparatus, an RRC message including a MAC address list including a MAC address used as a transmission destination address used in the Ethernet (registered trade name) datagram.
